(19) United States
(12) Patent Application Publication
(10) Pub. No.: US 2025/0325927 A1
(43) Pub. Date: Oct. 23, 2025

(54) WATER FILTRATION ASSEMBLY OF AN APPLIANCE

(71) Applicant: Haier US Appliance Solutions, Inc., Wilmington, DE (US)

(72) Inventors: Bradford Stewart Gasior, Louisville, KY (US); Gregory Sergeevich Chernov, Louisville, KY (US)

(21) Appl. No.: 18/639,414

(22) Filed: Apr. 18, 2024

(51) Int. Cl. B01D 35/143; C02F 1/00; F25D 23/12

(52) U.S. Cl. CPC B01D 35/143; C02F 1/003; F25D 23/126; C02F 2209/445; C02F 2307/12; F25D 2323/121

(57) ABSTRACT

A water filtration assembly includes a filtration housing. The filtration housing includes a translucent portion. The water filtration assembly also includes a light source positioned on the water filtration assembly and in optical communication with the translucent portion of the filtration housing. The light source is positioned and configured to illuminate the translucent portion of the filtration housing.

### FIELD OF THE INVENTION

The present subject matter relates generally to refrigerator appliances, and more particularly to power and illumination features for a water filtration assembly of a refrigerator appliance.

### BACKGROUND OF THE INVENTION

Refrigerator appliances generally include a cabinet that defines a chilled chamber. A wide variety of food items may be stored within the chilled chamber. The low temperature of the chilled chamber relative to ambient atmosphere assists with increasing a shelf life of the food items stored within the chilled chamber. Refrigerator appliances may also be equipped with a dispensing system. Such dispensing systems typically provide chilled water and/or ice from inside of the refrigerator appliance to a dispensing outlet accessible from inside or outside of the refrigerator appliance.

Certain refrigerator appliances further include water filter assemblies for filtering water. Water filter assemblies can filter water entering the refrigerator appliances to provide filtered water to various refrigerator appliance components, such as an ice maker and/or a water dispenser of the aforementioned dispensing system. Such filtering can improve a taste and/or an appearance of water within the refrigerator appliances.

Over time, a filter media within the water filter assembly becomes fouled with contaminants removed, e.g., filtered, from the flow of water such that the filter needs to be replaced periodically. However, since the filter media is internal to the water filter assembly the status of the filter media, e.g., fouled, clean, or other status, is not readily ascertainable, such as by visual inspection of the water filter assembly while installed in the refrigerator appliance. As a result, water filters may be left in place beyond their usable life, which may result in decreased performance, such as decreased filtration efficacy, reduced water pressure downstream of the filter, and other undesired effects.

In view of the aforementioned, the present disclosure is directed to an illuminated water filtration assembly of a refrigerator appliance, where such illumination may be used to convey status of the water filtration assembly, such as filter media status or other status information.

### BRIEF DESCRIPTION OF THE INVENTION

Aspects and advantages of the invention will be set forth in part in the following description, or may be obvious from the description, or may be learned through practice of the invention.

In an aspect, the present disclosure is directed to a refrigerator appliance having a cabinet. The cabinet includes a plurality of internal walls. The plurality of internal walls define a chilled chamber. The refrigerator appliance also includes a water filtration assembly. The water filtration assembly includes a filtration housing selectively mounted to at least one wall of the plurality of walls via a manifold. The filtration housing includes a translucent portion. The water filtration assembly also includes a light source positioned on the water filtration assembly and in optical communication with the translucent portion of the filtration housing. The light source is positioned and configured to illuminate the translucent portion of the filtration housing.

In another aspect, the present disclosure is directed to a water filtration assembly. The water filtration assembly includes a filtration housing. The filtration housing includes a translucent portion. The water filtration assembly also includes a light source positioned on the water filtration assembly and in optical communication with the translucent portion of the filtration housing. The light source is positioned and configured to illuminate the translucent portion of the filtration housing.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides an elevation view of a refrigerator appliance according to exemplary embodiments of the present disclosure.

FIG. 2 provides a perspective view of the exemplary refrigerator appliance of FIG. 1.

FIG. 3 provides an elevation view of the exemplary refrigerator appliance of FIG. 1, wherein the doors are shown in an open position.

FIG. 4 provides a simplified side elevation view of an embodiment of a water filtration assembly within a refrigerator appliance according to exemplary embodiments of the present disclosure.

FIG. 5 provides a perspective view of a water filtration assembly, including an illustration of a second electrical contact sub-assembly separated from the rest of the water filtration assembly for clarity.

FIG. 6 provides an exploded perspective view of the exemplary water filtration assembly of FIG. 5.

FIG. 7A provides a side perspective view of the water filter of the exemplary water filtration assembly of FIG. 5.

FIG. 7B provides a cross-sectional perspective view of the water filter of the exemplary water filtration assembly of FIG. 5.

FIG. 7C provides an exploded perspective view of the water filter of the exemplary water filtration assembly of FIG. 5.

FIG. 8 provides a cross-sectional perspective view of the housing cap of the exemplary water filtration assembly of FIG. 5.

FIG. 9 provides a cross-sectional perspective view of a portion of the filter label of the exemplary water filtration assembly of FIG. 5.

FIG. 10 provides a perspective view of a portion of the housing cap of the exemplary water filtration assembly of FIG. 5

FIG. 11 provides a simplified side perspective view of an embodiment of a water filtration assembly within a refrigerator appliance according to exemplary embodiments of the present disclosure.

FIG. 12 provides an exploded perspective view of the water filter of the exemplary water filtration assembly of FIG. 11.

FIG. 13 provides a perspective view of an exemplary label according to one or more embodiments of the present disclosure, which may be incorporated into a water filtration assembly such as the exemplary water filtration assembly of FIG. 5.

FIG. 14 provides an enlarged view of a portion of the exemplary label of FIG. 13.

FIG. 15 provides another enlarged view of a portion of the exemplary label of FIG. 13.

FIG. 16 provides a perspective view of a portion of an exemplary electrical circuit according to one or more embodiments of the present disclosure which may be provided on a label such as the exemplary label of FIG. 13.

FIG. 17 provides a perspective view of an exemplary filtration housing including a translucent portion with an exemplary label thereon according to one or more embodiments of the present disclosure, which may be incorporated into a water filtration assembly such as the exemplary water filtration assembly of FIG. 5.

FIG. 18 provides a perspective view of another exemplary label according to one or more additional embodiments of the present disclosure, which may be incorporated into a water filtration assembly such as the exemplary water filtration assembly of FIG. 5.

FIG. 19 provides an enlarged view of a portion of the exemplary label of FIG. 18.

FIG. 20 provides a perspective view of a water filtration assembly including a filtration housing having a translucent portion according to one or more embodiments of the present disclosure.

FIG. 21 provides a perspective view of a water filtration assembly including a filtration housing having a translucent portion according to one or more embodiments of the present disclosure, where the translucent portion is illuminated in a first manner.

FIG. 22 provides a perspective view of the water filtration assembly of FIG. 21, where the translucent portion is illuminated in a second manner.

FIG. 23 provides a perspective view of the water filtration assembly of FIG. 21, where the translucent portion is illuminated in a third manner.

FIG. 24 provides a perspective view of a water filtration assembly including a filtration housing having a translucent portion according to one or more embodiments of the present disclosure, where a filter media is in a first condition.

FIG. 25 provides a perspective view of the water filtration assembly of FIG. 24, where the filter media is in a second condition.

FIG. 26 provides a perspective view of the water filtration assembly of FIG. 24, where the filter media is in a third condition.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

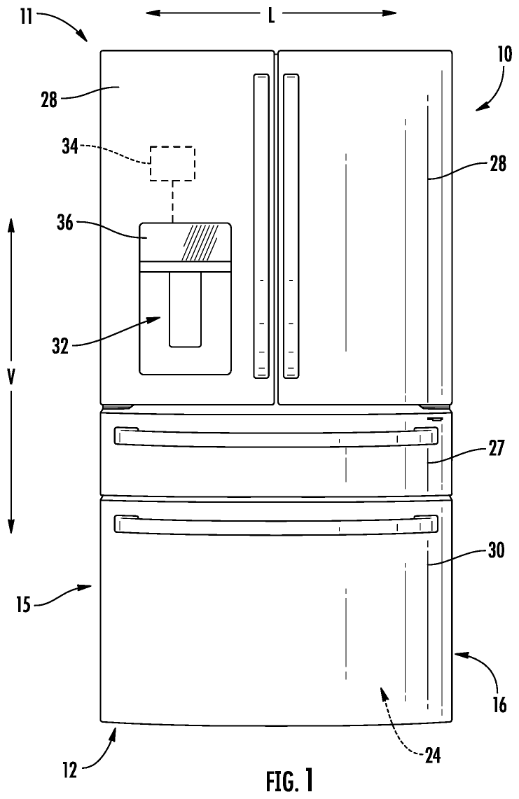

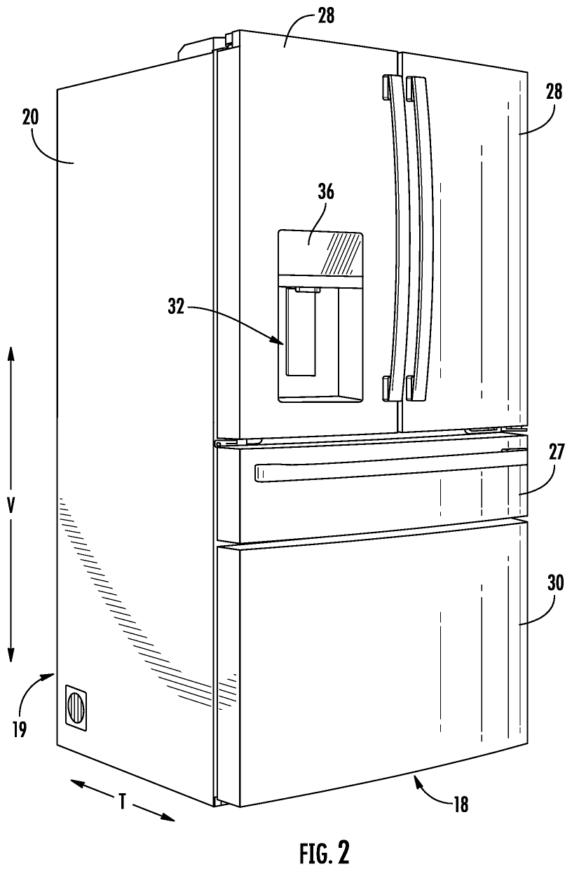

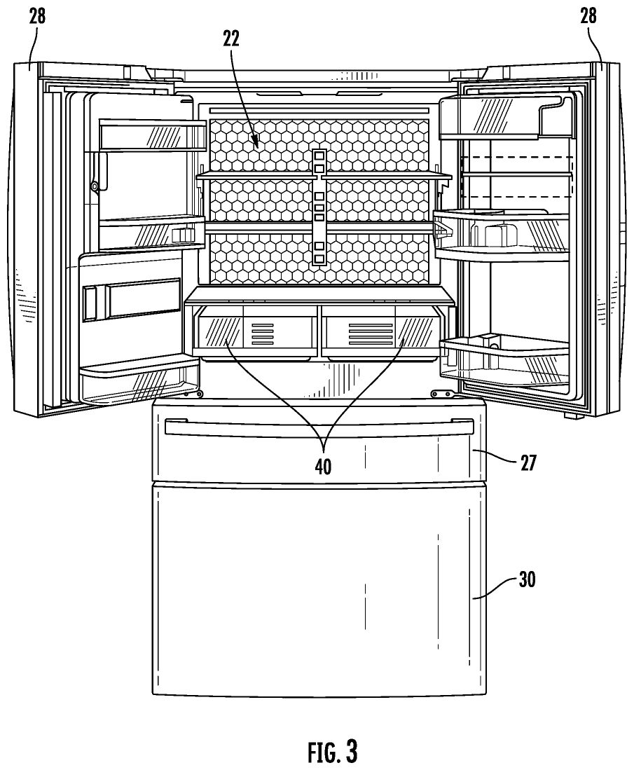

Referring now to the drawings, FIG. 1 illustrates a front view of an embodiment of a refrigerator appliance 10 according to the present disclosure. FIG. 2 illustrates a perspective view of the refrigerator appliance 10 of FIG. 1. FIG. 3 illustrates a front view of the refrigerator appliance 10 of FIG. 1 with refrigerator doors 28 in an open position. Referring particularly to FIG. 1, the refrigerator appliance 10 extends between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V, L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary chamber.

Referring back to FIG. 1, operation of the refrigerator appliance 10 can be regulated by a controller 34 that is operatively coupled to a user interface panel 36. The user interface panel 36 may provide selections for user manipulation of the operation of the refrigerator appliance 10 to modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming and/or user manipulation of the user interface panel 36.

The controller 34 may include a memory and one or more microprocessors, CPUs or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

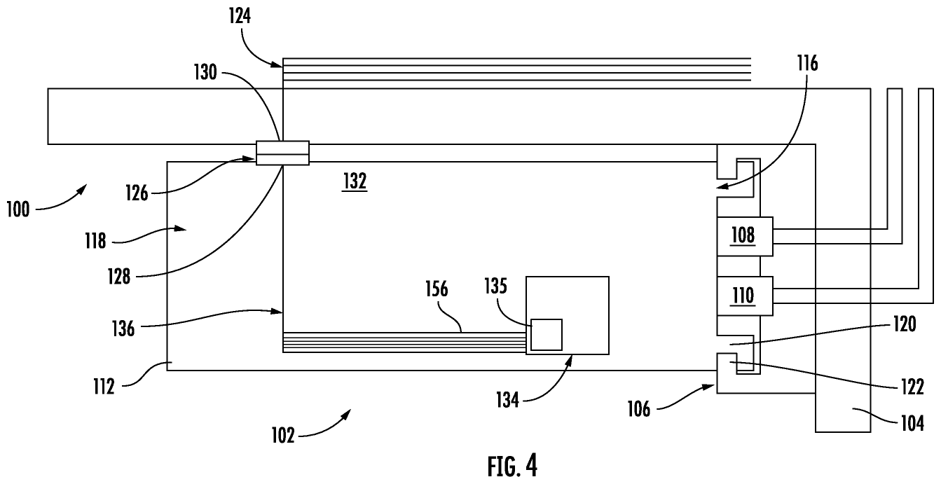

Referring now to FIG. 4, a simplified side view of an embodiment of an appliance wall 104 of an appliance 100 (such as an interior wall, an exterior wall, a side wall, etc.) having a water filtration assembly 102 secured thereto according to the present disclosure is illustrated. In particular, as shown, the water filtration assembly 102 has a filtration housing 112 and a water filtration media (not shown) within the filtration housing 112. In addition, as shown, the filtration housing 112 may have a cylindrical configuration. In further embodiments, the filtration housing 112 may have any other suitable configuration other than a cylindrical configuration. Moreover, as shown, the water filtration assembly 102 may also include a liquid receiving space 132 within the filtration housing 112 and an electronics compartment 134 having one or more electronic components (not shown) housed, at least in part, therein. In such embodiments, the electronics compartment 134 is fluidly isolated from the liquid receiving space 132, and thus fluidly isolated from the flow of water received within the liquid receiving space 132.

In further embodiments, as shown, the water filtration assembly 102 includes a manifold 106 that can be mounted to the appliance wall 104 of the appliance 100. Accordingly, as shown, the manifold 106 may generally contain a filter latching/mating interface and water connections therein.

Furthermore, as shown, the appliance 100 generally includes a water source (not shown) that provides water to and from the water filtration assembly 102, e.g., through the manifold 106 via a water inlet 108 and a water outlet 110. Thus, in certain embodiments, the water filtration assembly 102 is in fluid communication with the water inlet 108 and the water outlet 110.

In further embodiments, the filtration housing 112 includes a first end 116 opposite a second end 118. As such, in an embodiment, the first end 116 is for securing the water filtration assembly 102 to the manifold via the filter latching/mating interface, with the manifold 106 being secured to the appliance wall 104 of the appliance 100. In particular embodiments, as shown in FIG. 4, the filter latching/mating interface may include the first end 116 of the filtration housing 112 having one or more interlocking features 120 and corresponding interlocking features 122 of the manifold 106. In such embodiments, the interlocking features 120 of the first end 116 of the filtration housing 112 are configured to engage with the corresponding interlocking features 122 of the manifold 106 for securing the filtration housing 112 to the appliance 100. In further embodiments, the first end 116 of the filtration housing 112 may be secured to the manifold 106 using any suitable means.

Referring still to FIG. 4, the water filtration assembly 102 further includes an electrical connection 126 electrically coupling the water filtration assembly 102 to a power source (not shown) and/or a controller (e.g., controller 34 illustrated in FIG. 1 and described above). In certain embodiments, the power source may be any suitable source of electricity. More specifically, as shown, the electrical connection 126 may include at least one first electrical contact 128 positioned on the filtration housing 112 and at least one second electrical contact 130 positioned on the appliance wall 104 of the appliance 100. Accordingly, in an embodiment, the first electrical contact(s) 128 is configured to align with the second electrical contact(s) 130 when the filtration housing 112 is mounted to the appliance wall 104 regardless of an orientation of the filtration housing 112, e.g., regardless of which side of the filtration housing 112 is facing the appliance wall 104.

Furthermore, as shown, the electrical connection 126 may include one or more electrical harnesses 136, 124. Accordingly, a first electrical harness 136 is configured to electrical couple the first electrical contact 128 to an electronics compartment 134 having one or more electronic components housed within the filtration housing 112. Moreover, as shown, a second electrical harness 124 is configured to electrically couple the second electrical contact 130 to the power source (not shown) and/or any other communication device, such as a controller.

Furthermore, as shown, the electrical connection 126 is separate and spaced apart from the manifold 106 and the flow of water received therein, e.g., separate and spaced apart from the water inlet port(s) 108 and the water outlet port(s) 110. As such, in an embodiment, when the first electrical contact(s) 128 contacts the second electrical contact(s) 130, power is provided to the water filtration assembly 102 from the power source, for example, via the electrical connection 126. In addition to providing power or in the alternative, one or more other signals for communication or sensing may also be provided to the water filtration assembly 102 when the first electrical contact(s) 128 contacts the second electrical contact(s) 130.

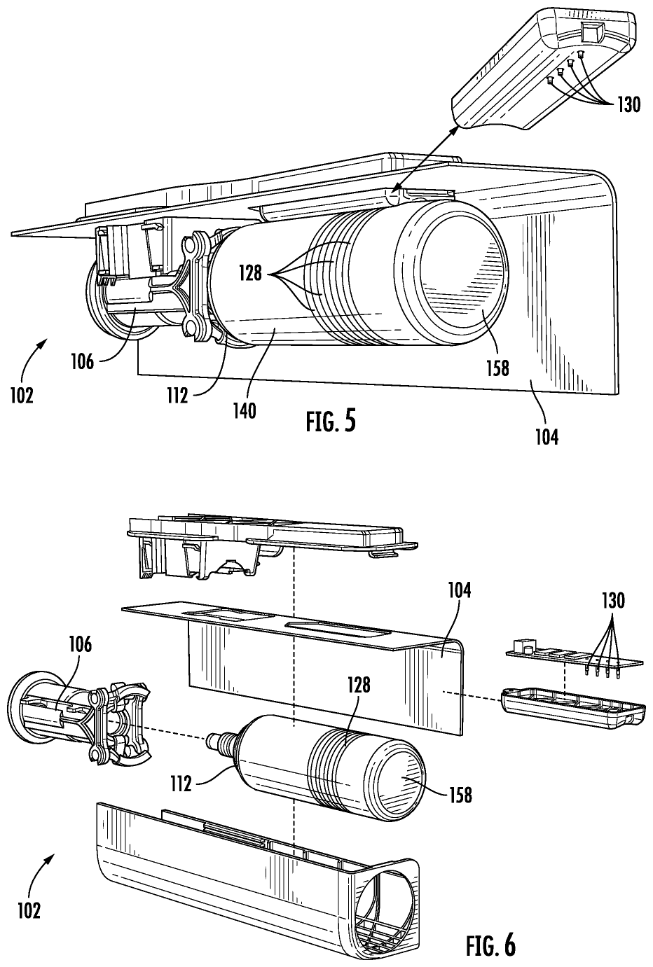

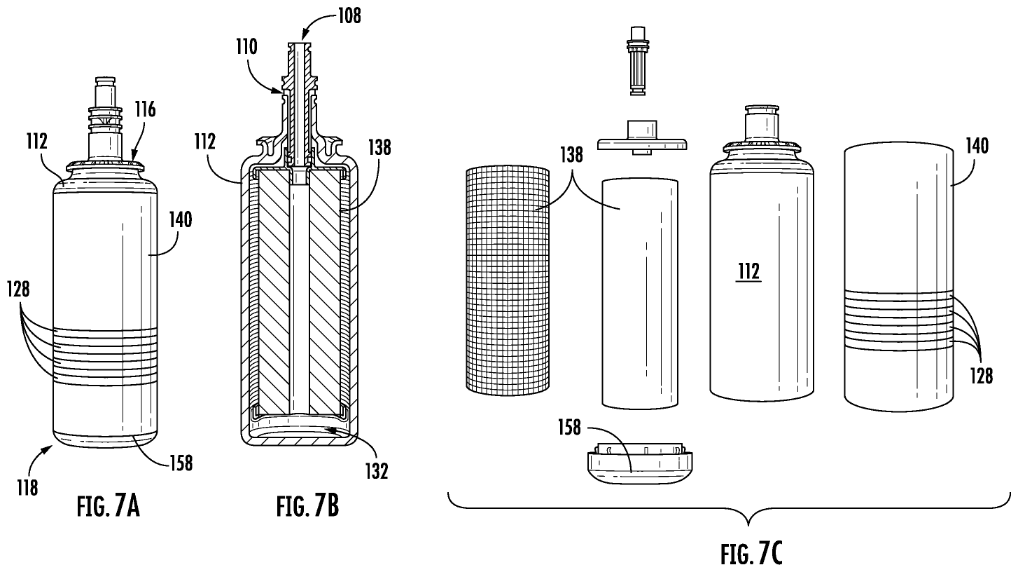

Turning now generally to FIGS. 5 through 12, a housing label 140 may be disposed on the filtration housing 112. Generally, the housing label 140 is separate and spaced apart from the fluid inlet port 108 and the fluid outlet port 110. For instance, the housing label 140 may include an adhesive layer or coating (e.g., applied to an interior surface of the housing label 140) that adheres or sticks to an external surface of filtration housing 112. Additionally or alternatively, a separate exterior label or coating (e.g., fitted polymer, such as a shrink wrap or vacuum-sealed layer) may be provided to hold housing label 140 to filtration housing 112. Optionally, housing label 140 may extend about at least a portion of filtration housing 112. As would be understood, housing label 140 may include printed text, labeling, or figures indicative or descriptive of the water filtration assembly 102. Nonetheless, as would also be understood, the present disclosure is not limited to any particular printed text, labeling, or figures.

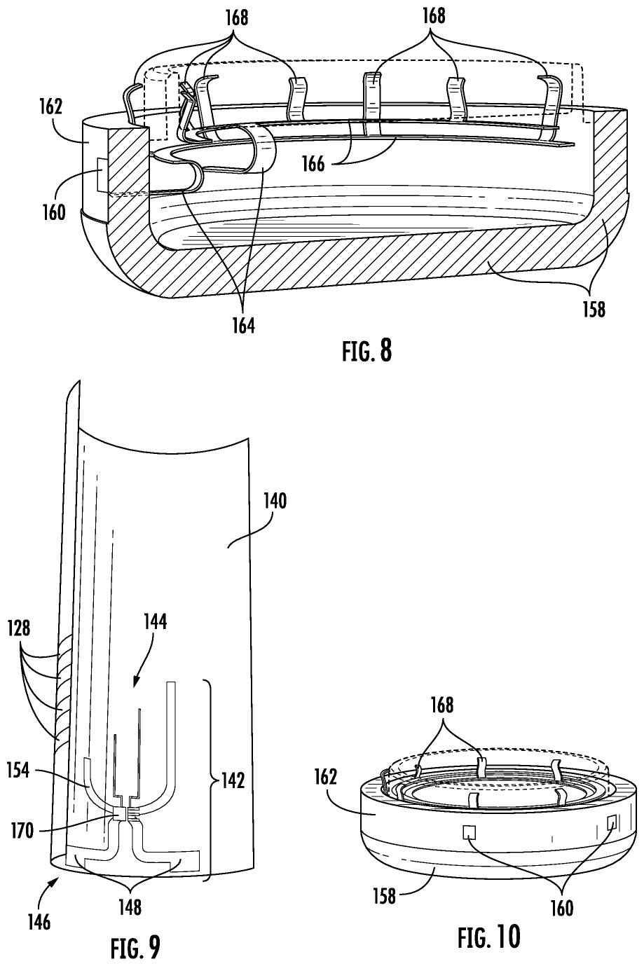

In some embodiments, an electrical connector (e.g., electrical passthrough facilitating an electrical current to flow therethrough) 142 (FIG. 9) is provided on, with, beneath, or through the housing label 140. Generally, the electrical connector 142 defines an intermediate electrical path 154 (e.g., singular path or, alternatively, plurality of electrically parallel paths) that extends outside (e.g., partially or, alternatively, fully outside) of at least a portion of the filtration housing 112. When assembled (e.g., such that filtration housing 112 is mounted within appliance in fluid connection with a water source), intermediate path 154 may conduct power or communication signals between the water filtration assembly 102 and the separate appliance 100 (FIG. 4).

As shown, electrical connector 142 may extend from a first connector end 144 to a second connector end 146. Generally, one or more circuit conductors (e.g., wires, conductive traces, pins, etc.) through which a current may be conducted between first connector end 144 and second connector end 146 extend between the first connector end 144 and the second connector end 146. In some embodiments, electrical connector 142 is joined to the housing label 140, such as between first connector end 144 and second connector end 146 (e.g., by an adhesive, attachment panel, embedding material, or other suitable conductor attachment structure, as would be understood). Optionally, both first connector end 144 and second connector end 146 (e.g., the entirety of electrical connector 142 between first connector end 144 and second connector end 146) may be disposed outside of the liquid receiving space 132, electronics compartment 134 (FIG. 4), or general interior of filtration housing 112.

In certain embodiments, first connector end 144 is defined as or at first electrical contact 128. Thus, the intermediate electrical path 154 may extend from the first electrical contact 128 to conduct power or communication signals between the water filtration assembly 102 and the separate appliance 100 (FIG. 4). In embodiments wherein multiple discrete contacts 128 are provided, a similar number of branches of intermediate electrical path 154 may be provided (e.g., in parallel to each other). In additional or alternative embodiments, second connector end 146 is defined as or at one or more housing contact pads 148. The contacts pads 148 may correspond (e.g., in number and placement) to the (e.g., parallel) electrical branches of path 154 or, alternatively, be distinct (e.g., in number and placement) from the (e.g., parallel) electrical branches of path 154 while still being in electrical communication with the same (e.g., directly or, alternatively, indirectly, such as through an electrical chip 170). Additionally or alternatively, the contact pad(s) 148 may be disposed on or fixed to the external surface of filtration housing 112. Optionally, the housing contact pads 148 may be disposed beneath or on an internal surface of housing label 140. When assembled, the intermediate electrical path 154 may extend to the housing contact pad(s) 148 to conduct power or communication signals between the water filtration assembly 102 and the separate appliance 100 (FIG. 4).

Turning especially to FIGS. 5 through 10, the first electrical contact(s) 128 may include axially spaced pads. In particular, first electrical contact(s) 128 may be formed or be shaped as one more conductive rings. For instance, first electrical contact 128 may extend around at least a portion of filtration housing 112. Optionally, a plurality of first electrical contacts 128 may be provided as conductive rings. In particular, as shown, the water filtration assembly 102 may include a plurality of first electrical contacts 128 extending around at least a portion of the filtration housing 112. Optionally, a plurality of second electrical contacts 130 may be arranged on the appliance wall 104 of the appliance 100 (FIG. 4).

In particular, as shown in the illustrated embodiments, each of the plurality of first electrical contacts 128 may generally have a ring-shaped configuration extending around a circumference, e.g., an entire circumference or approximately the entire circumference (as noted above “approximately” includes a ten percent margin of error, e.g., approximately the entire circumference as used herein includes at least ninety percent of the circumference), of filtration housing 112. Accordingly, the ring-shaped first electrical contact(s) 128 allow for the filtration housing 112 to be installed in any orientation such that, regardless of the orientation, the first electrical contact(s) 128 align with the second electrical contact(s) 130 (FIG. 4). In such embodiments, the ring-shaped first electrical contacts 128 may be arranged adjacent to each other and may be axially spaced apart from each other (e.g., equally spaced or separated by differing distances along an axial direction defined along or parallel to the central longitudinal axis of the filtration housing 112). In the illustrated embodiment, four first electrical contacts 128 are provided, however, it should be understood that more than four or less than four first electrical contacts 128 may be employed in the flexible circuit of the present disclosure.

Moreover, it should be understood that the number of second electrical contacts 130 (FIG. 4) generally corresponds to the number of first electrical contacts 128, e.g., four second electrical contacts 130 may be provided to match with the illustrated four first electrical contact 128. For example, as shown, each of the plurality of second electrical contacts 130 is arranged on the appliance wall 104 of the appliance 100 (FIG. 4) to align with and contact one of the plurality of first electrical contacts 128 when the water filtration assembly 102 is mounted within the appliance 100. In some embodiments, the second electrical contacts 130 include or are provided as spring-loaded contact pins, such as pogo pins, biased outward or downward toward first electrical contacts 128.

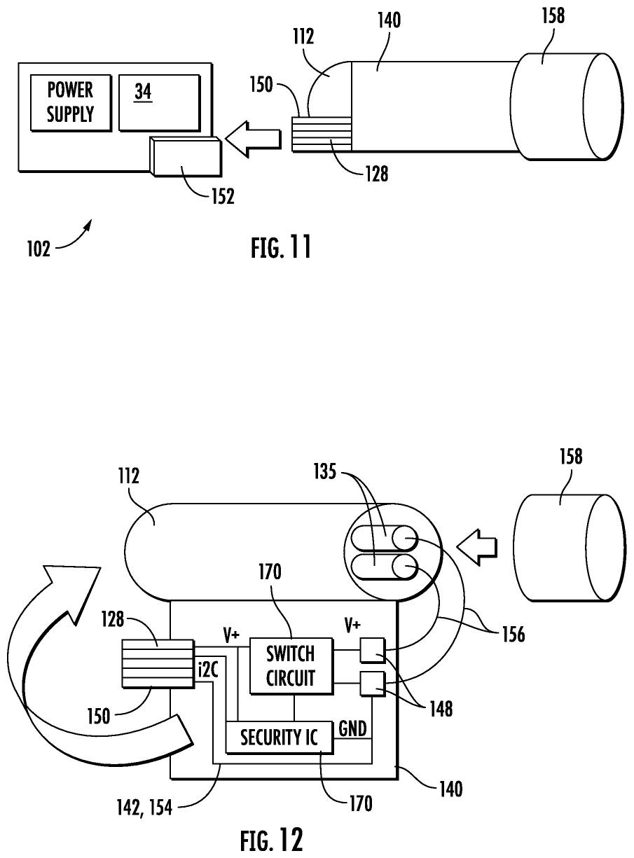

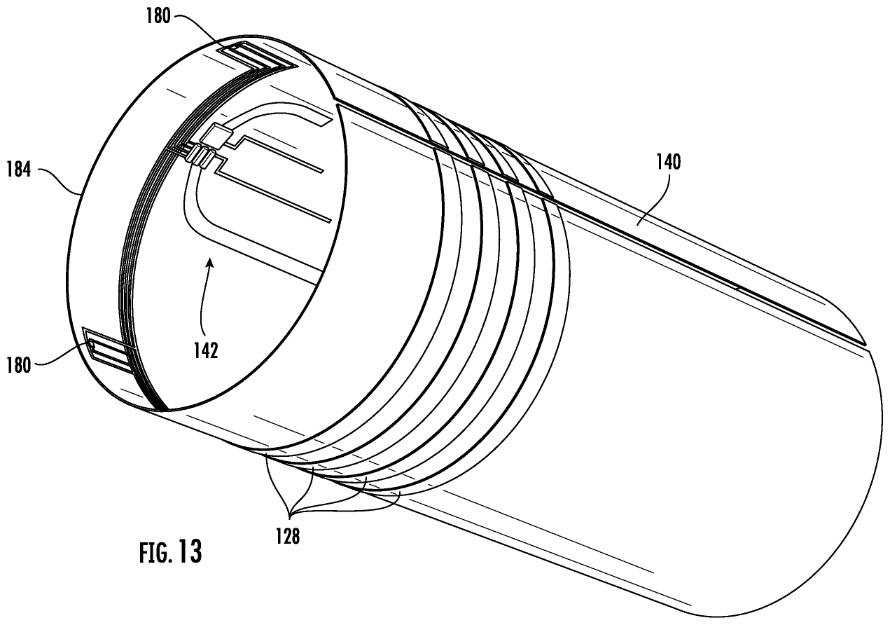

Turning briefly to FIGS. 11 and 12, although certain embodiments may include one or more conducive rings at the first electrical contacts 128, alternative embodiments may include a rigid card plug 150 (e.g., provided at or as part of the first electrical contact 128). Such a rigid card plug 150 may include, for instance, an edge connector having a printed circuit board including conductive traces or pathways leading to the edge of the board that are intended to plug into a matching contact socket 152. As shown, the rigid card plug 150 may extend outward from the housing label 140 (e.g., to the intermediate electrical path below the housing label 140).

The contact socket 152 may be fixed or mounted on the separate appliance 100 (FIG. 4), such as a female card socket to receive the rigid card plug 150. Moreover, the contact socket 152 may be in electrical communication with the power source or controller 34 (e.g., to direct power or communication signals between the appliance 100 (FIG. 4) and the water filtration assembly 102).

Returning generally to FIGS. 5 through 12, within the filtration housing 112, an internal electrical path 156 may be disposed in electrical communication with the intermediate electrical path 154. Specifically, the internal electrical path 156 may connect the intermediate electrical path 154 to the one or more electronics components 135 (FIG. 4) provided within the filtration housing 112 (e.g., within the electronics compartment 134-FIG. 4). For instance, as noted above, one or more housing contact pads 148 may be provided on (e.g., fixed on an external surface of) the filtration housing 112 to connect to the internal electrical path 156. In turn, the housing contact pads 148 may be in electrical communication between the internal electrical path 156 and the intermediate electrical path 154.

In some embodiments, the internal electrical path 156 may be connected to the intermediate electrical path 154 or housing contact pads 148 through one or more intermediary connectors. For instance, a housing cap or end cap 158 may be selectively disposed on the filtration housing 112 (e.g., to close the first housing end 116 or second housing end 118). Fixed to the end cap 158 may be one or more cap contact pads 160 in electrical communication with the internal electrical path 156. When assembled, the cap contact pads 160 may thus be in electrical communication between the internal electrical path 156 and the intermediate electrical path 154.

In certain embodiments, the cap contact pads 160 circumferentially align with and conductively contact the housing contact pads 148. For instance, the cap contact pads 160 may be embedded from an exterior surface of the end cap 158 at a circumferential rim 162 thereof while one or more mated conductor bodies 164 extend inward through the circumferential rim 162 to the interior of the filtration housing 112. In some such embodiments, the cap contact pads 160 are overmolded within the end cap 158. The housing label 140 may cover at least a portion of the circumferential rim 162 such that the housing contact pads 148 sit over or radially outward from the cap contact pads 160 (e.g., at the same circumferential location about the filtration housing 112). In turn, an intermediate electrical connection may be formed between the contact pads 148, 160 to permit electrical communication between the two paths 154, 156.

As noted above, the conductor bodies 164 may extend from the cap contact pads 160. In optional embodiments, each conductor body 164 includes a conductive trunk 166 that extends from the cap contact pad 160 and a plurality of conductive branches 168 held within the filtration housing 112. Thus, a discrete conductor body 164 or conductive trunk 166 may extend from each discrete cap contact pad 160. As shown, each of the conductive branches 168 may be circumferentially spaced apart from each other within filtration housing 112. Optionally, the discrete branches 168 of one conductive trunk 166 may be circumferentially interposed between the discrete branches 168 of another conductive trunk 166 such that two or more branches 168 of one conductive trunk 166 are circumferentially interrupted or separated by the branch 168 of another conductive trunk 166. Additionally or alternatively, a radial collar within filtration housing 112 may radially separate the conductive branches 168 of two or more conductive trunks 166 (e.g., such that the radial collar surface acts as a radially barrier between the two sets of branches 168). Thus, one set of conductive branches 168 may be arranged radially inward of another set of conductive branches 168.

Turning now especially to FIGS. 9 and 12, a validating electrical circuit or electrical chip 170 may be disposed along the intermediate electrical path (e.g., on the housing label 140). Specifically, between the first connector end 144 and the second connector end 146, the electrical chip 170 may be positioned to interrupt electrical communication or the conductive lines in general. Included on the electrical chip 170 may be one or more electrical components, circuits, or processors (e.g., configured to selectively restrict/permit power or communication signals through the electrical chip 170, as would be understood in light of the present disclosure). In some embodiments, the electrical chip 170 is configured to evaluate one or more electrical signals from the first electrical contact 128 and selectively permit power transfer through the electrical chip 170 to the filtration housing 112 based on the evaluation. For instance, the electrical chip 170 may include a Field-Effect Transistor (FET) circuit configured to selectively permit or restrict electrons through the electrical chip 170. Additionally or alternatively, the electrical chip 170 may include a chip processor or controller configured to receive an authentication communication signal from the controller 34 and match the authentication communication signal to a stored condition. In response to matching the authentication communication signal, the chip processor or controller may permit power or communication signals through the electrical chip 170 (e.g., to the internal electrical path 156). Alternately, if the chip processor or controller of chip 170 fails to match the authentication communication signal, the chip processor or controller may be configured to restrict or prevent power or communication signals through the electrical chip 170 (e.g., to the internal electrical path 156).

Referring now generally to FIGS. 13 through 26, in some embodiments, the water filtration assembly may include a light source, e.g., one or more Light Emitting Diodes (LEDs) 180. In such embodiments, the filtration housing 112 may include a non-opaque portion, e.g., a translucent portion which may also be transparent, such as a window, an illuminable indicator, or other translucent portion. As used herein, “translucent” is used broadly to include any material which permits light to pass through it, such that a translucent material may also be transparent but is not necessarily transparent. In some exemplary embodiments, the light source, e.g., one or more LEDs 180, may be positioned on the water filtration assembly 102 and in optical communication with the translucent portion of the filtration housing 112, such that the light source, e.g., LED(s) 180, is or are positioned and configured to illuminate the translucent portion of the filtration housing 112. For example, the one or more LEDs 180 may be positioned on the housing label 140, such as on an interior side or internal side (e.g., a side which faces the filtration housing 112) of the housing label 140. However, the one or more LEDs 180 may also or instead be positioned in various locations within the water filtration assembly 102 to be in optical communication with the translucent portion of the filtration housing 112 in order to illuminate the translucent portion of the filtration housing 112 when the one or more LEDs 180 are activated. In additional embodiments, the light source may include other light sources as well as or instead of the illustrated exemplary LEDs 180, and/or the number and relative position of the provided light sources, e.g., LEDs 180, may vary from the illustrated exemplary embodiments, among other possible variations in the configuration of the light source.

As shown, the light sources, e.g., one or more LEDs 180, may be coupled in-line with one or more of the electrical paths described above, such as the intermediate electrical path 154, such that the LEDs 180 may be powered via the electrical connection 126. The one or more LEDs 180 may be connected to the electrical path(s) by one or more internal traces 182, e.g., internal to the housing label 140. For example, the LEDs may receive power and/or control signals from the power source (not shown) and/or controller (e.g., controller 34 illustrated in FIG. 1 and described above) of the appliance 100 via the electrical connection 126. In additional embodiments, the LEDs 180 may be powered from another power source or via another power connection, such as wireless (e.g., Radio Frequency or RF) power transfer, and the LEDs 180 may also be in wireless communication with the controller as well as or instead of wireless power transfer. As will be discussed further below, in some embodiments, the one or more LEDs 180 may be illuminable in various manners, such as in different colors, steadily or intermittently, among other possibilities. In such embodiments, the control signals which cause the LED 180 to activate in the various manners, e.g., colors, may be entirely generated by the controller of the appliance 100, or some of the processing (e.g., selecting the manner in which to illuminate the LEDs 180) may be performed by a chip on the water filtration assembly 102. For example, the water filtration assembly 102, e.g., the chip thereon, may be in communication with the controller of the appliance 100 wirelessly, as mentioned, or via an inter-integrated circuit (I2C) communication bus for transmission of such control signals.

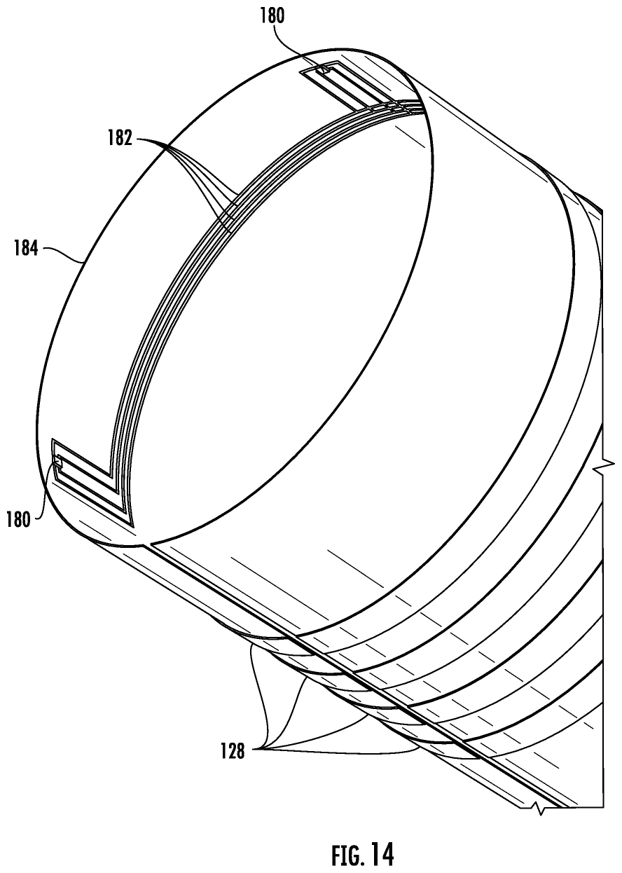

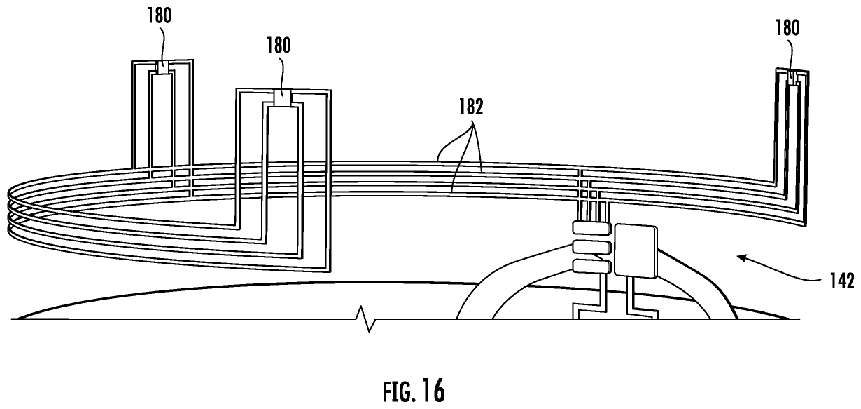

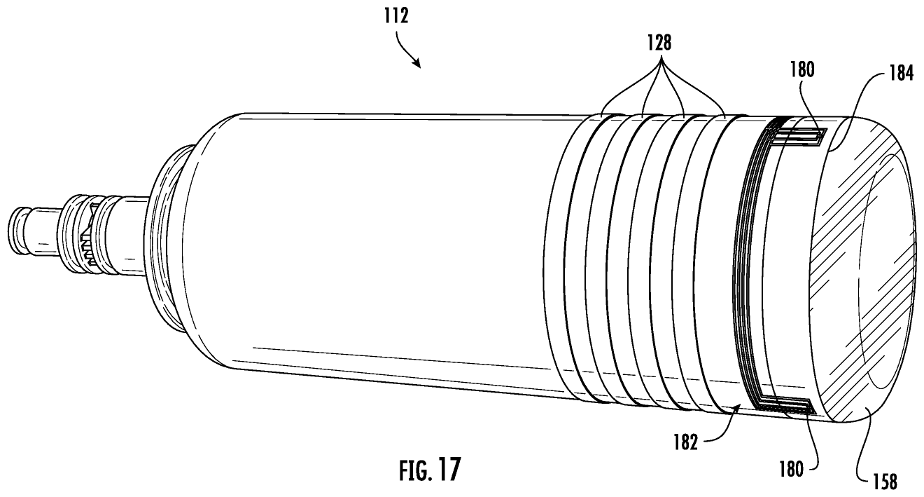

Referring now to FIGS. 13 through 17 specifically, in some embodiments, the light source may be or may include a plurality of LEDs 180 arranged circumferentially around the filtration housing 112, e.g., around the housing label 140 thereon, proximate to an end 184 of the housing label 140. For example, the LEDs 180 may be considered proximate the end 184 when the LEDs 180 are spaced apart from the end 184 by no more than about 20% of an axial length of the housing label 140. Such circumferential arrangement of the plurality of LEDs 180 may be best seen, e.g., in FIG. 13, which provides a perspective view of the housing label 140 as a whole; in FIG. 14, which provides an enlarged perspective view of the end 184 of the housing label 140 and adjacent portions; and in FIG. 16 which provides a perspective view of a portion of the electrical circuit, including the plurality of LEDs 180 and the internal traces 182, illustrated separately from the housing label 140.

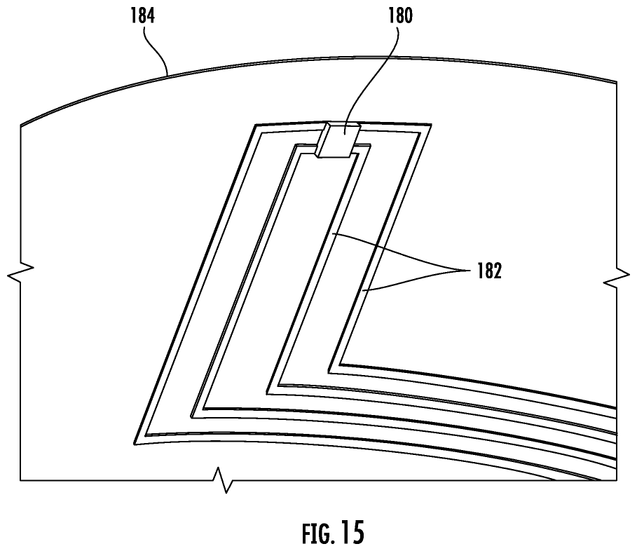

In some embodiments, e.g., as illustrated in FIG. 15, each LED may comprise a single LED, such as a single color LED or a multicolor (e.g., Red Green Blue or other multicolor) LED. In additional embodiments, multiple LEDs may be provided at each location, e.g., where the plurality of LEDs 180 illustrated in FIG. 16 includes LEDs 180 at three locations, a single LED 180 (such as a multicolor LED) may be provided at each location, or multiple single-color LEDs 180 may be provided at each of the three locations. For example, referring to the three locations illustrated in FIG. 16, three single-color LEDs 180 may be provided at each location, such as a red LED, a blue LED, and a yellow LED at each location, for a total of nine LEDs 180. In additional embodiments with multiple LEDs 180 at each location, other suitable colors and numbers of colors may be provided.

Turning now to FIG. 17, a perspective view of an exemplary filtration housing 112 is provided, with the housing label 140 transparent, such that both external traces (e.g., contacts 128) and internal traces 182 (e.g., connected to the LEDs 180 as described above) may be seen. In some embodiments, e.g., as illustrated in FIG. 17, the translucent portion of the filtration housing 112 may be the end cap 158. In embodiments where the end cap 158 is translucent, the end 184 of the housing label 140 at which the plurality of LEDs 180 are arranged may be positioned proximate to or abutting the end cap 158. For example, in some embodiments, the end 184 of the label 140 may directly overlie (e.g., along a radial direction defined by the cylindrical housing 112 in the illustrated example embodiments) the circumferential rim 162 (FIG. 8) of the end cap 158. When so positioned, the plurality of LEDs 180 arranged circumferentially around the filtration housing 112, e.g., around the label 140 thereon, proximate end 184 are thereby positioned and configured to illuminate the translucent portion, e.g., translucent end cap 158, of the filtration housing 112.

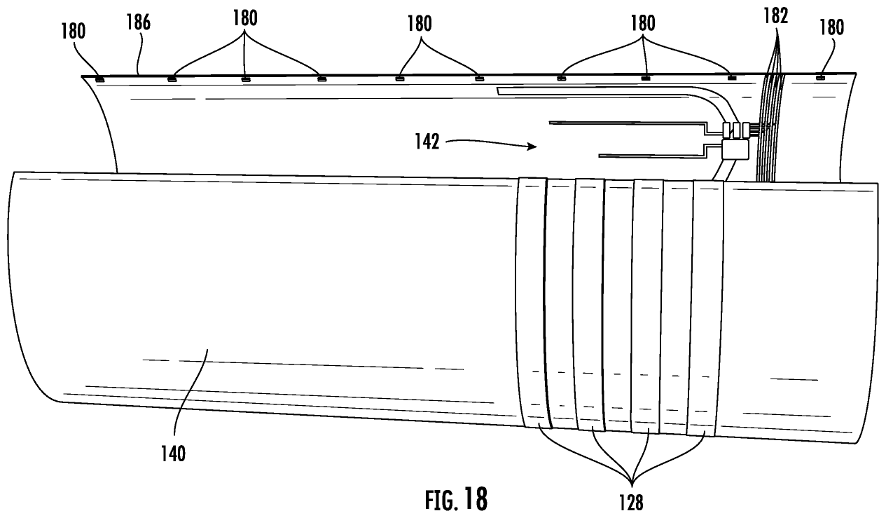

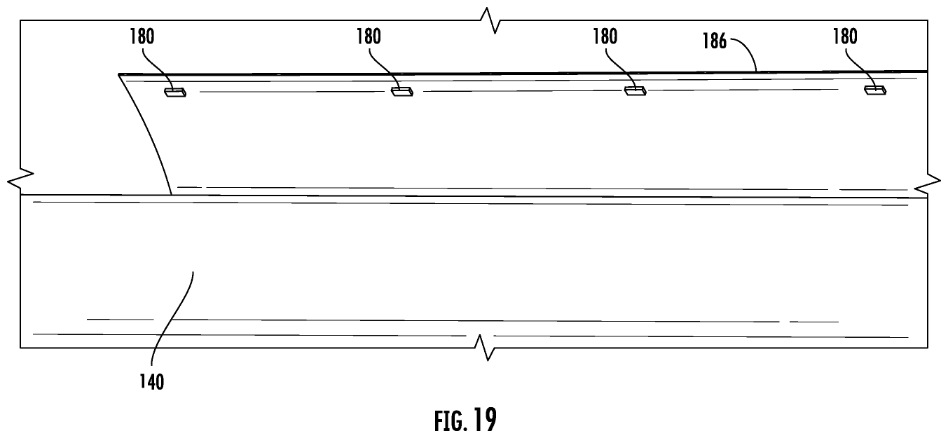

Referring now to FIGS. 18 through 20, in some embodiments, the light source may be or may include a plurality of LEDs 180 arranged axially along the filtration housing 112, such as along an axial direction defined by or parallel to a central longitudinal axis of the housing 112. For example, as illustrated in FIGS. 18 and 19, the plurality of LEDs 180 may be arranged in a linear array, e.g., may be colinear, along a line that is generally parallel to the axial direction. In particular, the plurality of LEDs 180 may be so arranged at or proximate to (where proximate to is used in this context to include spaced apart by up to 20% of a circumference of the filtration housing 112) an edge 186 of the filtration label 140, where the edge 186 is oriented approximately along the axial direction.

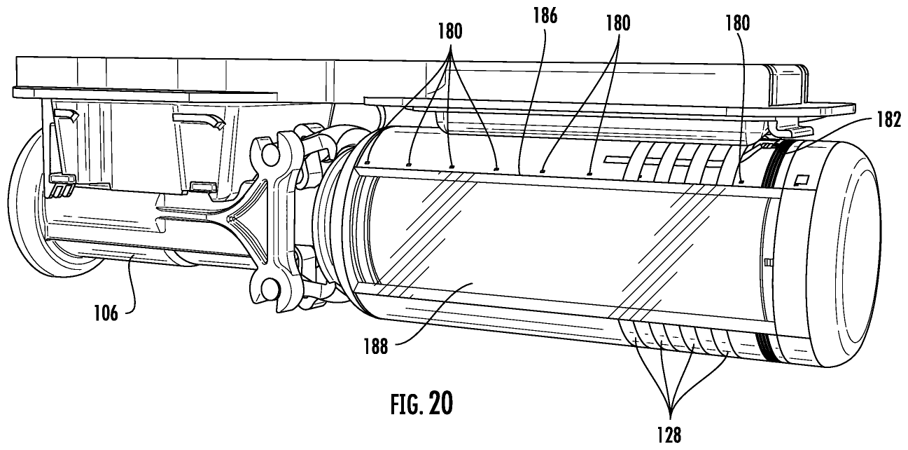

Referring now specifically to FIG. 20, in some embodiments, the translucent portion of the filtration housing 112 may be a window 188 formed in a portion of a side wall of the filtration housing 112. In some embodiments, the window 188 may be transparent, whereby the filter media inside the filtration housing 112 may be visible through the window 188. In particular, the one or more LEDs 180 at the edge 186 of the label 140 may be positioned and configured to illuminate the window 188 when the one or more LEDs 180 are activated, e.g., to provide easier viewing of the filter media inside the filtration housing 112. For example, as may be seen in FIG. 20, the edge 186 of the housing label 140 may be adjacent or adjoining an edge of the window 188, whereby the plurality of LEDs 180 may illuminate the window 188 when the plurality of LEDs 180 are activated.

As mentioned above, in some embodiments, the one or more LEDs 180 may be illuminable in more than one manner, e.g., in multiple colors and/or may be illuminated steadily or intermittently (e.g., blinking or flashing). Such different manners of illumination may be used to convey a filter status, such as a fouling status of the filter media, to a user. For example, in some embodiments, the translucent portion of the filtration housing 112 may be illuminated in a first manner when the filter is new, in a second manner when the filter is approaching replacement, e.g., when less than 20% (or any other suitable proportion) of the useful life of the filter media is remaining, and in a third manner when the filter is due or overdue for replacement. In additional embodiments, the one or more LEDs 180 may be illuminated in only two different manners, e.g., a first manner when the filter is OK and a second manner when the filter is due or overdue, or the one or more LEDs 180 may be illuminated in more than three different manners.

For example, the first manner may include illuminating the one or more LEDs 180 steadily when the filter is new or nearly new, the second manner may include intermittent blinking of the one or more LEDs 180 (such as a sequence of flashes, e.g., three flashes, followed by a period of steady illumination, then repeating the sequence periodically) when the filter is at or beyond a first threshold of useful life (e.g., about 20% useful life remaining as mentioned above), and the third manner may include continuous blinking or flashing of the one or more LEDs 180. In some embodiments, blinking or flashing the one or more LEDs 180 may also include changing color of the light emitted from the one or more LEDs 180, such as illuminating the translucent portion of the filtration housing 112 in a first color, then flashing a second color, e.g., when the filter status is intermediate.

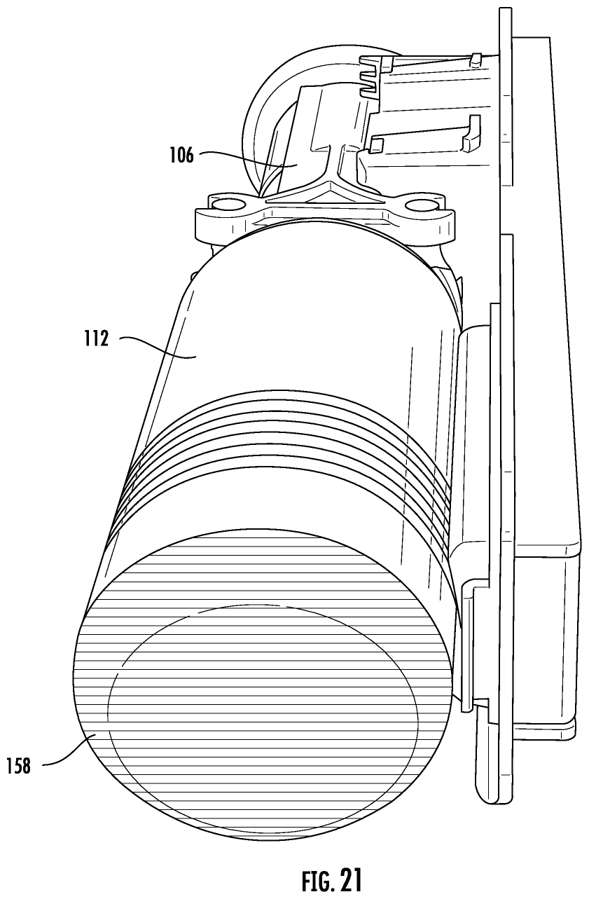

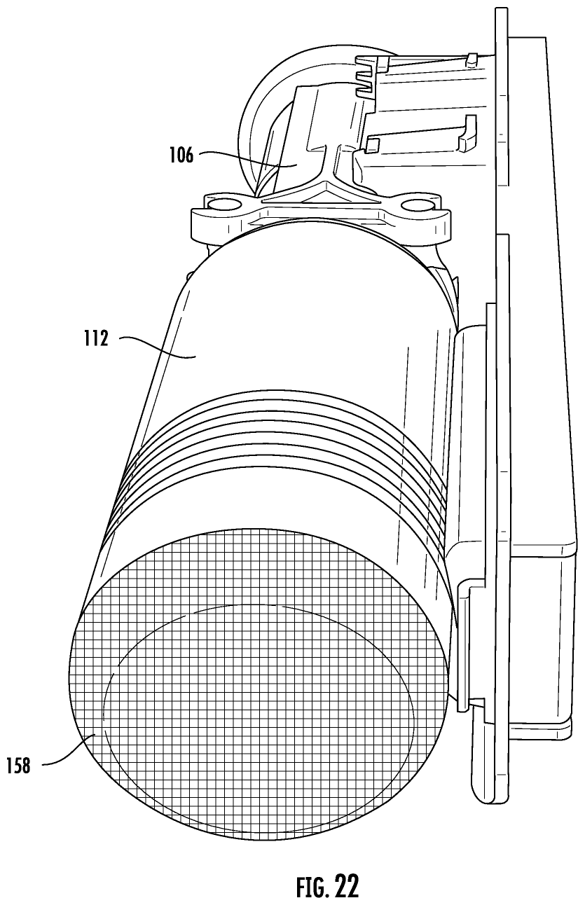

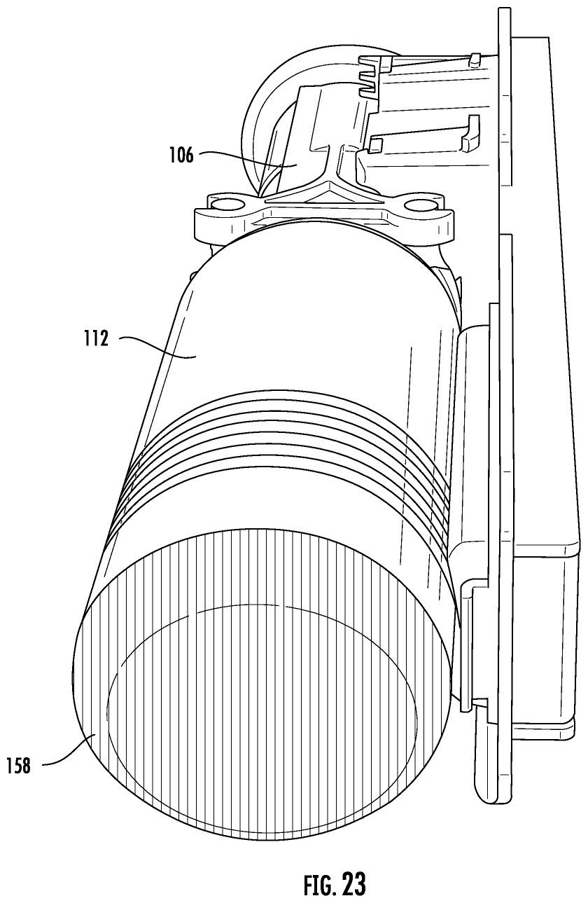

In another example, e.g., as illustrated in FIGS. 21 through 23, the different manners of illumination may include different colors. As noted above, the different colors may be provided by a multicolor LED or by a set of different single-colored LEDs. FIGS. 21 through 23 illustrate embodiments of the present disclosure in which the translucent portion of the filtration housing 112 is the end cap 158, and this is by way of example only, the LEDs 180 may be illuminated in different colors in other embodiments as well, e.g., embodiments where one or more LEDs 180 are provided in other locations as well as or instead of the circumferential arrangement. As shown in FIG. 21, illuminating the translucent portion in the first manner may include a first color emitted by the one or more LEDs 180, such as blue as illustrated in FIG. 21, when the filter is new or above a certain threshold of remaining useful life. When the filter reaches or passes below the threshold of remaining useful life (which may be, for example but without limitation, 20% remaining useful life), the translucent portion, e.g., translucent end cap 158, may be illuminated in a second manner, e.g., to indicate the diminished useful life of the filter. Such second manner may include activating the one or more LEDs 180 (or otherwise commanding the one or more LEDs 180, e.g., by the controller of the appliance 100 and/or a chip on the water filtration assembly 102, e.g., on the housing label 140) to emit a second color different from the first color. For example, as indicated in FIG. 22, the second color may be yellow or gold. Turning now to FIG. 23, when the filter useful life has reached or passed a second threshold, e.g., 10% or less remaining useful life, such as zero remaining useful life, the translucent portion, e.g., end cap 158, of the filtration housing 112 may be illuminated in a third manner, e.g., a third color, such as red as indicated in FIG. 23. In additional embodiments, more than three colors may be used at additional predetermined threshold amounts or percentages of remaining useful life, and/or different colors may be used to represent the various filter statuses other than the example colors mentioned herein.

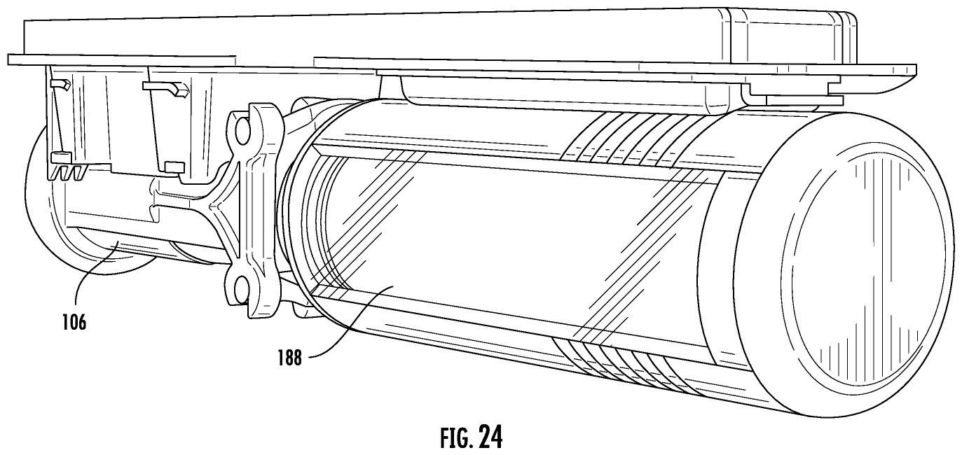

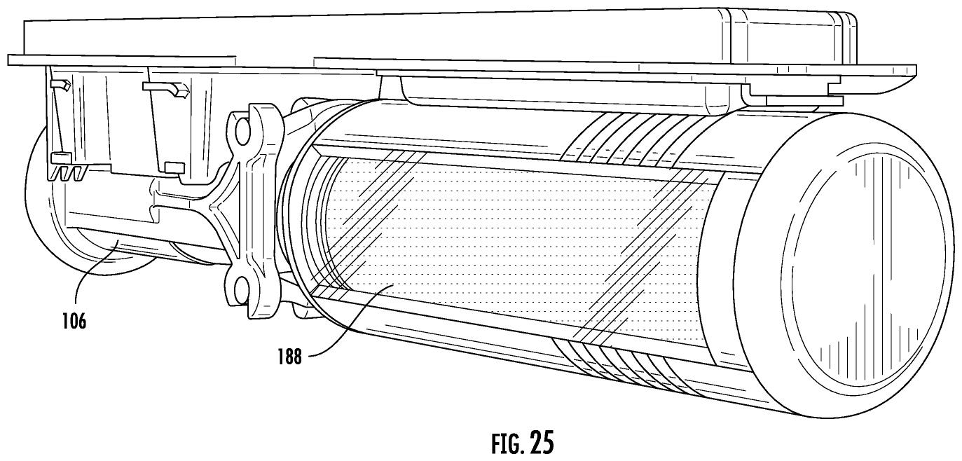

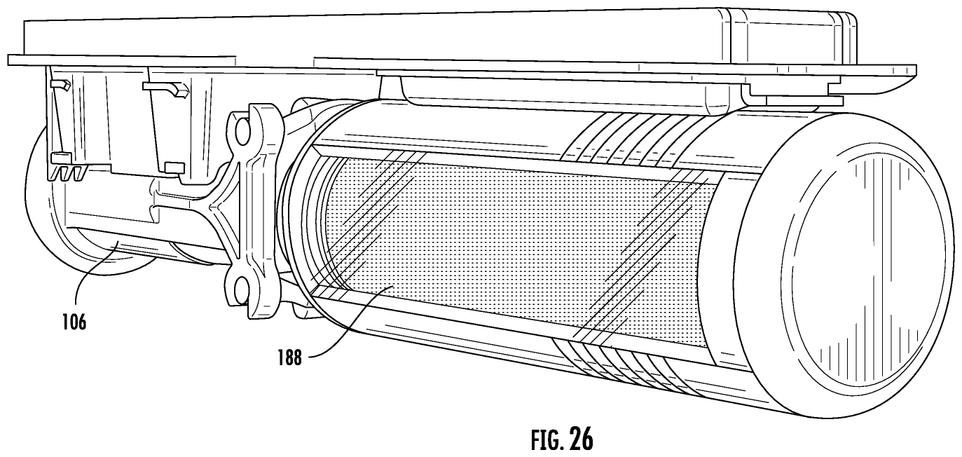

Referring now to FIGS. 24 through 26, in some embodiments, the filter status, e.g., degree of fouling of the filter media, may be directly observable through the translucent portion of the filtration housing 112, e.g., window 188. For example, FIG. 24 illustrates an appearance of the filter media in a new or clean state, which may be observable when illuminated by the one or more LEDs 180, e.g., when the window 188 is illuminated by the one or more LEDs 180 positioned at the edge 186 of the housing label 140. Also by way of example, FIG. 25 illustrates the filter media in an intermediate state, e.g., mild or moderately fouled. As noted with respect to FIG. 24, such status may be visually ascertained without removing the filtration housing 112 from the manifold 106, e.g., through the window 188 when the window 188 is illuminated by the one or more LEDs 180 proximate to the edge 186 of the housing label 140. Thus, the condition of the filter illustrated in FIG. 25 (and/or FIG. 22 as described above) may indicate to a user that it is time to purchase or obtain a replacement filter (e.g., a replacement filtration housing) in order to have one on hand when the current filter is completely used up. As illustrated in FIG. 26, illuminating the translucent portion, e.g., window 188, such that the filter media is visible through the translucent portion may provide the user with a readily perceived, e.g., visual, notification and reminder that the filter is fouled and due for replacement. Additionally, embodiments where the filter media is perceivable may also provide motivation for the user to replace the filter when the filter media is visibly fouled, e.g., the appearance of the fouled filter media may be unappetizing and may thus encourage the user to invest in a new filtration housing. As may be seen throughout FIGS. 24 through 26, the filter media may become darker and noticeably dirtier as the remaining useful life of the filter diminishes, which may be easily perceived by a user when the window 188 is illuminated by the one or more LEDs 180.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a cabinet comprising a plurality of internal walls, the plurality of internal walls defining a chilled chamber;
a water filtration assembly comprising a filtration housing selectively mounted to at least one wall of the plurality of walls via a manifold, the filtration housing comprising a translucent portion; and
a light source positioned on the water filtration assembly and in optical communication with the translucent portion of the filtration housing whereby the light source is positioned and configured to illuminate the translucent portion of the filtration housing.

2. The appliance of claim 1, wherein the translucent portion of the filtration housing comprises an end cap of the filtration housing.

3. The appliance of claim 2, wherein the light source comprises a plurality of LEDs arranged circumferentially around the filtration housing.

4. The appliance of claim 1, wherein the translucent portion of the filtration housing comprises a portion of a side wall of the filtration housing.

5. The appliance of claim 4, wherein the light source comprises a plurality of LEDs arranged axially along the filtration housing.

6. The appliance of claim 1, wherein the water filtration assembly further comprises a housing label disposed on the filtration housing, the light source positioned on an internal side of the housing label.

7. The appliance of claim 6, wherein the water filtration assembly further comprises at least one fluid inlet port and at least one fluid outlet port secured to the manifold for receiving fluid from a fluid source and an electrical connection electrically coupling the water filtration assembly to a power source, wherein the electrical connection is separate and spaced apart from the manifold, the electrical connection comprising at least one first electrical contact located on the filtration housing and at least one second electrical contact located on the appliance wall, wherein, when the at least one first electrical contact is contacting the at least one second electrical contact, power is provided to the light source positioned on the water filtration assembly.

8. The appliance of claim 6, wherein the translucent portion of the filtration housing comprises an end cap of the filtration housing, wherein the light source comprises a plurality of LEDs arranged circumferentially around the housing label proximate to an end of the housing label.

9. The appliance of claim 6, wherein the translucent portion of the filtration housing comprises a portion of a side wall of the filtration housing, wherein the light source comprises a plurality of LEDs arranged axially along the housing label proximate to an edge of the housing label.

10. A water filtration assembly, comprising:
a filtration housing, the filtration housing comprising a translucent portion; and
a light source positioned on the water filtration assembly and in optical communication with the translucent portion of the filtration housing whereby the light source is positioned and configured to illuminate the translucent portion of the filtration housing.

11. The water filtration assembly of claim 10, wherein the translucent portion of the filtration housing comprises an end cap of the filtration housing.

12. The water filtration assembly of claim 11, wherein the light source comprises a plurality of LEDs arranged circumferentially around the filtration housing.

13. The water filtration assembly of claim 10, wherein the translucent portion of the filtration housing comprises a portion of a side wall of the filtration housing.

14. The water filtration assembly of claim 13, wherein the light source comprises a plurality of LEDs arranged axially along the filtration housing.

15. The water filtration assembly of claim 10, wherein the water filtration assembly further comprises a housing label disposed on the filtration housing, the light source positioned on an internal side of the housing label.

16. The water filtration assembly of claim 15, wherein the water filtration assembly further comprises at least one fluid inlet port and at least one fluid outlet port configured to be secured to a manifold for receiving fluid from a fluid source and an electrical connection electrically coupling the water filtration assembly to a power source, wherein the electrical connection is separate and spaced apart from the manifold, the electrical connection comprising at least one first electrical contact located on the filtration housing and at least one second electrical contact located on the appliance wall, wherein, when the at least one first electrical contact is contacting the at least one second electrical contact, power is provided to the light source positioned on the water filtration assembly.

17. The water filtration assembly of claim 15, wherein the translucent portion of the filtration housing comprises an end cap of the filtration housing, wherein the light source comprises a plurality of LEDs arranged circumferentially around the housing label proximate to an end of the filtration label.

18. The water filtration assembly of claim 15, wherein the translucent portion of the filtration housing comprises a portion of a side wall of the filtration housing, wherein the light source comprises a plurality of LEDs arranged axially along the housing label proximate to an edge of the filtration label.
